(19) United States
(12) Patent Application Publication
(10) Pub. No.: US 2018/0086155 A1
(43) Pub. Date: Mar. 29, 2018

(54) PNEUMATIC TIRE

(71) Applicant: TOYO TIRE & RUBBER CO., LTD., Osaka-shi (JP)

(72) Inventor: Keisuke Matsubara, Osaka-shi (JP)

(73) Assignee: TOYO TIRE & RUBBER CO., LTD., Osaka-shi (JP)

(21) Appl. No.: 15/498,904

(22) Filed: Apr. 27, 2017

(30) Foreign Application Priority Data
Sep. 27, 2016 (JP) 2016-188128

(51) Int. Cl. B60C 13/02; B60C 11/01

(52) U.S. Cl. CPC B60C 13/02; B60C 11/01

(57) ABSTRACT

Shoulder blocks arranged in a tire circumferential direction are provided in a shoulder region of a tread portion. A buttress region of the side wall portion is provided with a circumferential projection which extends along the tire circumferential direction, and a plurality of diametrical projections which are arranged in a lateral side of the shoulder block and extend to an inner side from the circumferential projection. A length of each of two paired diametrical projections which are adjacent to each other in the tire circumferential direction is greater than a distance of a center position in width of the paired diametrical projections. The two paired diametrical projections are differentiated from each other in their inside lengths. A diametrical projection having a relatively smaller inside length is formed higher than a diametrical projection having a relatively greater inside length among the two paired diametrical projections.

### BACKGROUND OF THE INVENTION

### Field of the Invention

The present invention relates to a pneumatic tire aiming at traveling on a punishing road such as a muddy terrain and a rocky stretch.

### Description of the Related Art

With regard to the pneumatic tire aiming at traveling on the punishing road, there has been known a technique in which a plurality of projections are provided side by side in a buttress region of a side wall portion. For example, patent documents 1 to 3 filed by the applicant of the present application should be referred. According to the configuration mentioned above, in a scene traveling on a muddy terrain and a sand pip, traction is generated by shear resistance of the projections and it is possible to improve a punishing road traveling property.

Patent document 1 discloses an example in which a plurality of projections are uniformly provided and a size of each of the projections is set to be constant. On the other hand, in the case that plural kinds of projections having different lengths are provided side by side, it is possible to obtain an effect of improving a catching action on a rocky stretch and enhancing a design property by applying a stereoscopic effect to a buttress region. However, since a fluctuation of a rubber volume is enlarged in the buttress region along a tire circumferential direction, dynamic unbalance of the tire tends to be deteriorated.

Patent document 4 describes a pneumatic tire in which a plurality of projections are provided side by side in a side wall portion. However, this is a technique for cooling a side wall reinforcing layer which is provided in a run flat tire, and Patent document 4 does not suggest solving means for the problem of the traction on the punishing road and the rubber volume fluctuation in the buttress region mentioned above.

### PRIOR ART DOCUMENT

### Patent Document

Patent Document 1: JP-A-2004-291936

Patent Document 2: JP-A-2010-264962

Patent Document 3: JP-A-2013-119277

Patent Document 4: JP-A-2013-249065

### SUMMARY OF THE INVENTION

The present invention is made by taking the above actual condition, and an object of the present invention is to provide a pneumatic tire which can achieve uniformization of a rubber volume in a buttress region while generating a necessary traction for traveling on a punishing road.

The object can be achieved by the following present invention. The present invention provides a pneumatic tire comprising a pair of bead portions, side wall portions which extend outward in a tire diametrical direction from each of the bead portions, and a tread portion which is connected to an outside end in the tire diametrical direction of each of the side wall portions, wherein shoulder blocks arranged in a tire circumferential direction are provided in a shoulder region of the tread portion, wherein a buttress region of the side wall portion is provided with a circumferential projection which extends along the tire circumferential direction, and a plurality of diametrical projections which are arranged in a lateral side of the shoulder block and extend to an inner side in the tire diametrical direction from the circumferential projection, wherein a length of each of two paired diametrical projections which are adjacent to each other in the tire circumferential direction is greater than a distance of a center position in width of the paired diametrical projections, and wherein two paired diametrical projections which are adjacent to each other in the tire circumferential direction are differentiated from each other in their inside lengths corresponding to lengths in the inner side in the tire diametrical direction than the circumferential projection, and a diametrical projection having a relatively smaller inside length is famed higher than a diametrical projection having a relatively greater inside length among the two paired diametrical projections.

In the tire, since a plurality of diametrical projections extend from the circumferential projections, rigidity of each of the diametrical projections coupled to each other by the circumferential projections can be enhanced. Further, since the length of each of a pair of adjacent diametrical projections is set to be larger than the distance of the center position in the width direction of the pair of diametrical projections, great shear resistance is generated by the diametrical projections in a scene traveling on the muddy terrain, and it is possible to well generate the traction which is necessary for traveling on the punishing road.

Further, in the tire, since two paired diametrical projections which are adjacent in the tire circumferential direction are different from each other in their inside lengths, it is possible to obtain an effect of improving the catching action on the rocky stretch and enhancing the design property by applying the stereoscopic effect to the buttress region. Further, it is possible to achieve the uniformization of the rubber volume in the buttress region by forming the diametrical projections having the smaller inside length higher than the diametrical projections having the larger inside length among the paired diametrical projections.

It is preferable that a distance of the center position in the width of two paired diametrical projections which are adjacent to each other in the tire circumferential direction is equal to or less than 45 mm. As a result, it is possible to effectively enhance the traction by appropriately increasing the arrangement pitch of the diametrical projections.

It is preferable that a ratio of an inside length of each of the diametrical projections is in a range between 0.3 and 1.2 in relation to the distance of the center position in width of two paired diametrical projections which are adjacent to each other in the tire circumferential direction. Since the ratio is equal to or more than 0.3, the inside length of the diametrical projections does not become too small, and the ratio is effective for securing the traction. Further, since the ratio is equal to or less than 1.2, the inside length of the diametrical projections doe not become larger than necessary.

It is preferable that a volume ratio of two paired diametrical projections which are adjacent to each other in the tire circumferential direction is equal to or less than 3.0. As a result, the fluctuation of the rubber volume does not become excessively large in the buttress region along the tire circumferential direction, and it is possible to suppress the deterioration of the dynamic unbalance.

### BRIEF DESCRIPTION OF THE DRAWINGS

FIG. 1 is a tire meridian half cross sectional view schematically showing an example of a pneumatic tire according to the present invention;

FIG. 2 is a side elevational view showing apart of a buttress region of the tire as seen from a tire width direction; and

FIG. 3 is an enlarged view of a substantial part in FIG. 1.

### DETAILED DESCRIPTION OF THE PREFERRED EMBODIMENTS

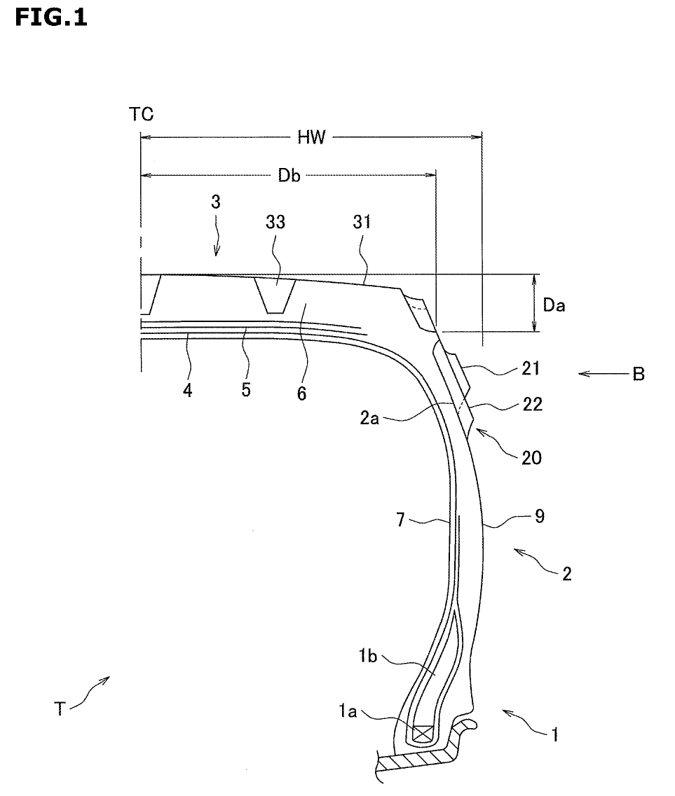

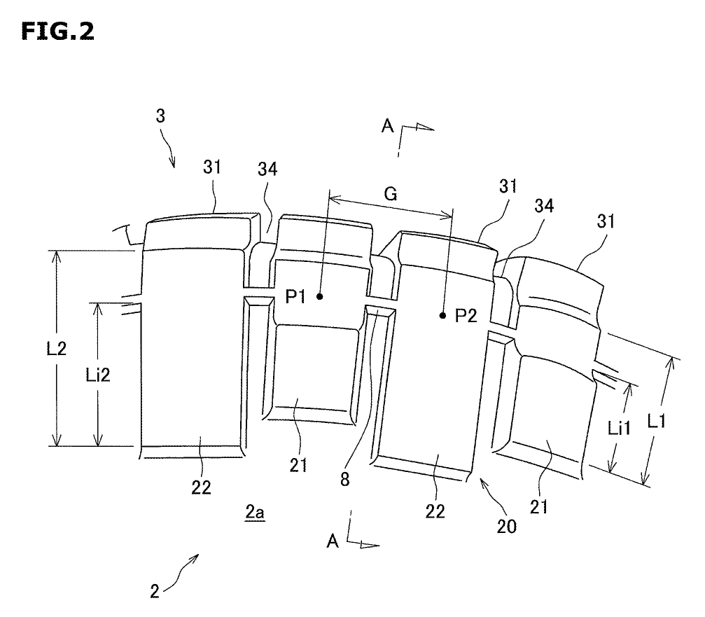

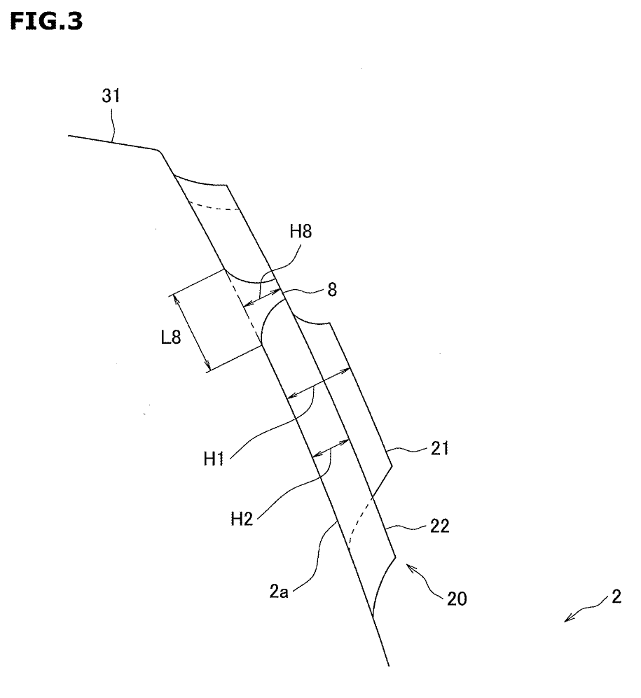

An embodiment of the present invention will be explained with reference to the drawings. FIG. 1 is a tire meridian half cross sectional view schematically showing an example of a pneumatic tire according to the present invention, and corresponds to a cross sectional view along a line A-A in FIG. 2. FIG. 2 is a side elevational view showing a part of a buttress region as seen from a tire width direction, and corresponds to a view as seen from an arrow B in FIG. 1. FIG. 3 is an enlarged view of a substantial part in FIG. 1.

A pneumatic tire T is an off-road pneumatic radial tire aiming at traveling on a punishing road which includes a muddy terrain and a rocky stretch. The tire T is provided with a pair of bead portions 1, side wall portions 2 which extend outward in a tire diametrical direction from each of the bead portions 1, and a tread portion 3 which is connected to an outside end in the tire diametrical direction of each of the side wall portions 2. The bead portion 1 is provided with an annular bead core 1a formed by coating a convergence body of steel wire with rubber, and a bead filler 1b which is arranged in an outer side in the tire diametrical direction of the bead core 1a.

The pneumatic tire T is further provided with a carcass 4 which is arranged between a pair of bead portions 1, and a belt 5 which is arranged in an outer peripheral side of the carcass 4 in the tread portion 3. The carcass 4 is formed into a toroidal shape as a whole, and is wound up its end portion in such a manner as to pinch the bead core 1a and the bead filler 1b. The belt 5 includes two belt plies which are layered inward and outward, and is provided with a tread rubber 6 in its outer peripheral side. A tread pattern having a main groove 33 and a lateral groove 34 is formed on a surface of the tread rubber 6.

An inner liner 7 is provided in an inner peripheral side of the carcass 4 for keeping pneumatic pressure. The inner liner 7 faces to an internal space of the tire T in which air is filled. In the side wall portion 2, the inner liner 7 is directly attached to an inner peripheral side of the carcass 4, and any other member is not interposed between them.

A shoulder block 31 arranged in the tire circumferential direction is provided in a shoulder region of the tread portion 3. The shoulder region is a region including a ground end which is positioned in an outer side in the tire width direction of the tread portion 3. The shoulder block 31 is sectioned by the main groove 33 which extends along the tire circumferential direction and the lateral groove 34 which extends crossing the main groove 33. As long as the shoulder block mentioned above is provided, a pattern in the other regions of the tread portion 3 is not particularly limited.

As shown in FIGS. 2 and 3, a buttress region of the side wall portion 2 is provided with a circumferential projection 8 which extends along the tire circumferential direction, and a plurality of diametrical projections 21 and 22 (hereinafter, refer to as projections 21 and 22) which extend to an inner side in the tire diametrical direction from the circumferential projection 8. Each of the projections bulges from a surface 2a of the side wall portion 2 along a profile line of the tire T. The circumferential projection 8 extends on an annular line along the tire circumferential direction, and each of the projections 21 and 22 according to the present embodiment extends not only to the inner side in the tire diametrical direction but also to an outer side from the circumferential projection 8.

The buttress region is a region in an outer side in a tire diametrical direction of the side wall portion 2, and more particularly a region in the outer side in the tire diametrical direction from a tire maximum width position 9, and corresponds to a region which does not ground contact at the normal traveling time on a flat paved road. Since the tire sinks down on a soft road such as the muddy terrain and the sand pip due to a weight of a vehicle, the buttress region ground contacts in a pseudo manner. The tire maximum width position 9 is a position where a profile line of the tier T is away from a tire equator TC at the maximum in the tire width direction. The profile line is a contour line which forms an outer surface of the side wall portion 2 except the projections, and normally has a meridian cross sectional shape which is defined by smoothly connecting a plurality of circular arcs.

In the present embodiment, a cross sectional shape of the circumferential projection 8 is famed into a flat chevron shape in its upper end surface, and more particularly famed into a composite volcano shape that an inclined surface is gently curved and narrowed. In the light of enhancement in the rigidity of the projection, a height H8 of the circumferential projection 8 is preferably equal to or more than 5 mm, more preferably goes beyond 5 mm, and is further preferably equal to or more than 8 mm. Further, in the light of enhancement in the rigidity of the projection, a contact length L8 of the circumferential projection 8 in relation to the outer surface 2a is preferably equal to or more than the height H8.

The circumferential projection 8 is set, for example, to a position where a distance Da shown in FIG. 1 is in a range between 20 and 40 mm. The distance Da is determined as a distance in the tire diametrical direction from a position of the outermost diameter of the tire T to a tire diametrical outside edge of an upper end surface of the circumferential projection 8. Further, the circumferential projection 8 is set, for example, to a position where a distance Db shown in FIG. 1 is 75% or more of a tire cross section half width HW. The distance Db is determined as a distance in the tire width direction from the tire equator TC to the tire diametrical outside edge of the upper end surface of the circumferential projection 8, and the tire cross section half width HW is determined as a distance in the tire width direction from the tire equator TC to the tire maximum width position 9.

As shown in FIG. 2, the projections 21 and 22 are arranged in the lateral side of the shoulder block 31, that is, are provided at positions in the outer side in the tire width direction of the shoulder block 31. In the present embodiment, there is shown an example in which two kinds of projections 21 and 22 are alternately arranged side by side. The projections 21 and 22 are arranged side by side in the same manner in a portion which is not illustrated, and the arranged elements construct an annular projections group 20. The projections constructing the annular projections group is not limited to two kinds, but the annular projections group may be famed by arranging three or more kinds (for example, three to ten kinds) of projections side by side.

Each of the projections 21 and 22 is famed into a rectangular shape in a side view, however, is not limited to this, and may be formed into the other polygonal shapes than the rectangular shape and the other shapes. In the present embodiment, a tire diametrical outside end (hereinafter, refer to as an outside end) of each of the projections 21 and 22 extending in the tire diametrical direction is connected to a side surface of the shoulder block 31. As a result, great shear resistance is generated by cooperation of the shoulder block 31 and the diametrical projections 21 and 22, and the traction is enhanced. Further, a tire diametrical inside end (hereinafter, refer to as an inside end) of each of the projections 21 and 22 is arranged in an outer side in the tire diametrical direction than the tire maximum width position 9.

Respective lengths L1 and L2 of a pair of projections 21 and 22 which are adjacent to each other in the tire circumferential direction are set to be greater than a distance G between center positions P1 and P2 in widths of the pair of projections 21 and 22. The lengths L1 and L2 are respectively determined as distances from edges in outside ends of the projections 21 and 22 to edges in inside ends. The center positions P1 and P2 in widths are respectively center positions of the projections 21 and 22 on an annular line along the circumferential projection 8, and the distance G is determined as a distance therebetween. The width of the gap existing between the adjacent projections 21 and 22 is set to be smaller than the widths of each of the projections 21 and 22 in both sides thereof.

In the tire T, since a plurality of projections 21 and 22 extend from the circumferential projection 8, rigidity of each of the projections 21 and 22 coupled to each other by the circumferential projection 8 is enhanced. Further, since the respective lengths L1 and L2 of a pair of projections 21 and 22 which are adjacent to each other are set to be greater than the distance G, great shear resistance is generated by the projections 21 and 22 in a scene traveling on the soft road such as the muddy terrain, the sand pip and the snowy road, and it is possible to well generate the traction which is necessary for traveling on the punishing road.

Further, in the tire T, a pair of projections 21 and 22 which are adjacent to each other in the tire circumferential direction are differentiated from each other in their inside lengths Li1 and Li2. Each of the inside lengths Li1 and Li2 is a length in an inner side in the tire diametrical direction than the circumferential projection 8. According to the configuration mentioned above, it is possible to obtain an effect of improving the catching action on the rocky stretch and enhancing the design property by applying the stereoscopic effect to the buttress region. Further, the projection 21 having the relatively small inside length Li1 is famed higher than the projection 22 having the relatively great inside length Lit. As a result, it is possible to achieve uniformization of the rubber volume in the buttress region.

In the present embodiment, the inside length Li1 is smaller than the inside length Li2, and the inside end of the projection 21 is arranged in the outer side in the tire diametrical direction than the inside end of the projection 22. A difference between the inside length Li1 and the inside length Li2 is preferably equal to or more than 5 mm for securing the above effect obtained by differentiating them, and is preferably equal to or less than 15 mm for suppressing the fluctuation of the rubber volume in the buttress region.

In the present embodiment, the projection 21 is formed higher than the projection 22. In other words, the height H1 of the projection 21 is greater than the height H2 of the projection 22. The heights H1 and H2 are determined as the maximum heights in the inner side in the tire diametrical direction than the circumferential projection 8. The greater the heights H1 and H2 are, the more the punishing road traveling property can be improved by enhancing the traction caused by the shear resistance, and the more the external damage resistance can be improved by making the external damage factor such as an angled portion in the rock face away from the outer surface 2a. Therefore, the heights H1 and H2 based on the outer surface 2a are preferably equal to or more than 5 mm and more preferably equal to or more than 8 mm.

Although the present embodiment does not employ, the other projection (hereinafter, refer to as an intermediate projection) extending in the tire diametrical direction may be interposed between a pair of projections 21 and 22 which are adjacent to each other in the tire circumferential direction. The intermediate projection is arranged in a lateral side of the lateral groove 34 which defines the shoulder block 31, and extends to the inner side in the tire diametrical direction from the circumferential projection 8. A relationship between the length of the projection and the distance of the center position in width mentioned above, and a relationship between the inside length and the height of the projection are both associated with the diametrical projection which is arranged in the lateral side of the shoulder block, and the intermediate projection is not considered in them.

It is preferable that the distance G between the center positions P1 and P2 in the widths of the pair of projections 21 and 22 which are adjacent to each other in the tire circumferential direction is equal to or less than 45 mm. In addition, the distance G is preferably 30 mm or more so that the length or the width of the diametrical projection do not become too small.

Each of ratios of the inside lengths Li1 and Li2 in relation to the distance G (that is, ratios Li1/G and Li2/G) is preferably in a range between 0.3 and 1.2. Since the ratio is equal to or more than 0.3, the inside lengths Li1 and Li2 of the projections 21 and 22 do not become too small, whereby the traction can be secured. In a more preferable embodiment, the ratio is equal to or more than 0.5. Further, since the ratio is equal to or less than 1.2, the inside lengths Li1 and Li2 of the projections 21 and 22 do not become larger than necessary. In a more preferable embodiment, the ratio is equal to or less than 1.0.

In the light of suppression of deterioration of the dynamic unbalance, a volume ratio of a pair of projections 21 and 22 which are adjacent to each other in the tire circumferential direction is preferably equal to or less than 3.0, and more preferably equal to or less than 2.0. The volume ratio is determined as a ratio of the other volume in relation to one volume, in a pair of diametrical projections which are adjacent to each other in the tire circumferential direction. Therefore, in the case that the one volume is equal to or smaller than the other volume, the preferable volume ratio is between 1.0 and 3.0. In the present embodiment, there is shown the example that the annular projections group 20 having the projections 21 and 22 with different volumes arranged side by side in the tire circumferential direction is formed, however, the structure is not limited to this.

The volume of each of the projections 21 and 22 is determined on the basis of the portion which bulges from the outer surface 2a, and the portion of the circumferential projection 8 protruding out of the side surface of each of the projections 21 and 22 is not considered as the volume of the projections 21 and 22. The volume of the projection can be determined, for example, by measuring concavities and convexities of the side wall portion with using a three-dimensional measuring tool and preparing a three-dimensional modeling while combining actually measured dimensional values as occasion demands. Alternatively, it can be determined by molding the side wall portion with using gypsum and utilizing the gypsum mold.

The annular projections group 20 may be formed in the side wall portion 2 at least in one side, however, in order to improve the punishing road traveling property and the external damage resistance, it is preferably formed in the side wall portions 2 in both sides.

Each of the dimensional values mentioned above is measured in a no-load normal state in which the tire is installed to a normal rim and a normal internal pressure is filled in the tire. The normal rim is a rim which is defined by a standard for every tire in a standard system including the standard on which the tire is based, for example, a standard rim in JATMA, “Design Rim” in TRA or “Measuring Rim” in ETRTO. Further, the normal internal pressure is a pneumatic pressure which is defined by each of the standards for every tire in the standard system including the standard on which the tire is based, and is a maximum pneumatic pressure in JATMA, the maximum value described in Table “TIRE LOAD LIMITS AT VARIOUS COLD INFLATION PRESSURES” in TRA, or “INFLATION PRESSURE” in ETRTO.

Since the pneumatic tire according to the present invention has the operations and effects as mentioned above and can improve the punishing road traveling property, the pneumatic tire can be preferably employed in a light truck such as a pickup truck for an off-road racing aiming at traveling on the punishing road including the muddy terrain and the rocky stretch, and for a vehicle dispatched to a disaster site.

The pneumatic tire according to the present invention can be configured in the same manner as the regular pneumatic tire except the formation of the projections as mentioned above in the buttress region of the side wall portion. Therefore, the conventionally known materials, shapes, structures and manufacturing methods can be employed in the present invention.

The present invention is not limited to the embodiment mentioned above, but can be improved and modified variously within the scope of the present invention.

What is claimed is:

1. A pneumatic tire comprising:
a pair of bead portions;
side wall portions which extend outward in a tire diametrical direction from each of the bead portions; and
a tread portion which is connected to an outside end in the tire diametrical direction of each of the side wall portions,
wherein shoulder blocks arranged in a tire circumferential direction are provided in a shoulder region of the tread portion,
wherein a buttress region of the side wall portion is provided with a circumferential projection which extends along the tire circumferential direction, and a plurality of diametrical projections which are arranged in a lateral side of the shoulder block and extend to an inner side in the tire diametrical direction from the circumferential projection,
wherein a length of each of two paired diametrical projections which are adjacent to each other in the tire circumferential direction is greater than a distance of a center position in width of the paired diametrical projections, and
wherein two paired diametrical projections which are adjacent to each other in the tire circumferential direction are differentiated from each other in their inside lengths corresponding to lengths in the inner side in the tire diametrical direction than the circumferential projection, and a diametrical projection having a relatively smaller inside length is formed higher than a diametrical projection having a relatively greater inside length among the two paired diametrical projections.

2. The pneumatic tire according to claim 1, wherein a distance of the center position in the width of two paired diametrical projections which are adjacent to each other in the tire circumferential direction is equal to or less than 45 mm.

3. The pneumatic tire according to claim 1, wherein a ratio of an inside length of each of the diametrical projections is in a range between 0.3 and 1.2 in relation to the distance of the center position in width of two paired diametrical projections which are adjacent to each other in the tire circumferential direction.

4. The pneumatic tire according to claim 1, wherein a volume ratio of two paired diametrical projections which are adjacent to each other in the tire circumferential direction is equal to or less than 3.0.
